(19) United States
(12) Patent Application Publication
(10) Pub. No.: US 2009/0149974 A1
(43) Pub. Date: Jun. 11, 2009

(54) METHOD OF EVALUATING THE PERFORMANCE OF A RELIEF PITCHER IN INSTANCES WITH INHERITED BASE RUNNERS

(76) Inventors: Paul Storch, Great Neck, NY (US); Joshua Lee Storch, Great Neck, NY (US)

Correspondence Address: LACKENBACH SIEGEL, LLP, LACKENBACH SIEGEL BUILDING, 1 CHASE ROAD, SCARSDALE, NY, 10583, US

(21) Appl. No.: 11/952,189

(22) Filed: Dec. 7, 2007

(51) Int. Cl. G06F 19/00

(52) U.S. Cl. 700/91

(57) ABSTRACT

A method of evaluating the performance of a relief pitcher in instances with inherited base runners factors through storage and processing of data as to when a pitcher inherits at least one player on base. The following steps of the method are disclosed: first, establishing the number of runs Ri scored by such inherited runners; second, establishing the number of appearances A in instances with inherited runners; third, establishing the number of outs; and, finally, evaluating the Relief Quotient “RQ” according to the formula: RQ=k(Ri+E)/A)ⁿ where k is first a predetermined constant selected to scale the RQ to a desired range of magnitudes, n is a second predetermined constant that may be positive or negative and E is a parameter that may be an integer or equal to 0.

### BACKGROUND OF THE INVENTION

1. Field of the Invention

The invention generally relates to baseball and, more particularly, to a statistical method for evaluating the performance of a relief pitcher.

2. Description of the Prior Art

Baseball thrives, and in large measure survives, by its ability to evaluate, differentiate and classify its product—namely, its players and teams. This is true for hitters, for pitchers, and, to a lesser extent, for position players in the field.

Who had the best season at the plate? Generally speaking, the batting average tells us.

Who had the most productive season? Perhaps it's the slugging percentage or the Runs Batted hi (RBI) that tells us. Or is it the statistic that indicates which player crossed home plate the most times (Runs Scored)? Perhaps it is the statistic that states who had the best on-base average, the most walks, or the most hits.

Measuring pitching performance has also been one of the most common subjects of statistics, and can be found in newspapers from the 1800s. Which pitcher won how many games? The won/loss columns tell us. This is the most widely used measure of a pitcher's worth. Which pitcher struck out the most batters? Which pitcher yielded the fewest walks? Which pitcher allowed the fewest hits? Which pitcher allowed the fewest batters to cross home plate due to his mistakes (the Earned Run Average, or “ERA”)? This is the second most widely used measure of a pitcher's worth, after the total amount of “wins.” Which pitcher had the most “saves,” so to speak, out of the bullpen? A “save” is credited to a relief (or “substitute”) pitcher when along with several other factors, the pitcher who starts the game is removed from the game while his team is in the lead, and the relief pitcher holds the opposite team in check so that his team remains ahead and goes on to win the game. (It has been said that the “blown save” is baseball's most “deflating moment, and its most haunting,” The New York Times, Mar. 31, 2002, Sect. 8a, p. 3.).

The following is a more specific definition of a “save” in pitching: A pitcher can earn a save by completing all three of the following terms: (1) Finishes the game won by his team; (2) Does not receive the win; (3) Meets one of the following three items: (a) Enters the game with a lead of no more than three runs and pitches at least one inning; (b) Enters the game with the tying run either on base, at bat or on deck; and/or (c) Pitches effectively for at least three innings.

The number of “saves” has been used for years as a measure of the value of a relief pitcher. Baseball is not immune to society's rush into specialization. Just as a general practitioner M.D. recommends a patient to a specialist, and an attorney might specialize in maritime law, baseball is becoming more and more specialized as to how it uses its players. Very few “complete”—nine-(or more)-inning games—are pitched by the starting pitchers. A manager will use a “pitch count” to determine how far his ace (the starting pitcher) can go. There are middle-inning (fifth seventh inning) relief pitchers, and there are “closers,” who finish pitching the game.

Relief pitching has become an art and a specialty. However, the statistics related to relief pitching have not kept pace.

Assume the following situation. Several relief pitchers have come into a different number of games and have “inherited” a different number of base runners. However, all of these relief pitchers end the season with similar numbers of saves. Because the actual games each pitcher entered can be widely disparate, a fixed number of saves—say, 15—might not have the same value for each pitcher. It's possible that reliever no. 1 pitched in twice as many games as reliever no. 2. Clearly, in such a case, “15 saves” would not mean that they are of equal value. And what of the situations in which each of these pitchers allowed runs or scores and did not “save” the game (“blown saves”)? Most of the baseball statistics we know are readily computed and reflect simple performance parameters. The common and not-so-common items used to measure pitching performance in the major leagues today include “Adjusted Pitching Runs” (“APR” or “PR/A”). This is an advanced pitching statistic used to measure the number of runs that a pitcher prevents from being scored compared to the League's average pitcher in a neutral park in the same amount of innings. This is similar to the “ERA” (“Earned Run Average”) and acts as a quantitative counterpart.

The above mentioned ERA is simply computed by the following formula:

ERA=R×9/I, where R=the number of earned runs and I=total no. of innings pitched.

The ERA is one of the oldest pitching statistics and is one of the most commonly used and understood statistics in the major leagues. Virtually every fan knows what it means, but many often forget the formula used to compute the pitcher's ERA.

The Earned Run Average Plus (“ERA+” or “RA”) is computed by dividing the league ERA by the ERA of a pitcher. This statistic uses a league-normalized ERA in the calculation and is intended to measure how well the pitcher prevented runs from being scoring relative to pitchers in the rest of the league. It is similar to the Hitters' PRO statistic.

Another commonly used statistic is the “Walks and Hits per Innings Pitched” (“WHIP”), which is computed as follows:

WHIP=H+W/I, where H=number of hits, W=number of walks, and I=total number of innings pitched. This is a popular statistic that is used and frequently discussed in certain leagues. It was developed to measure the approximate number of walks and hits a pitcher allows in each inning he pitches, and then to compare the value received to other pitchers to formulate a pitcher's index.

The winning percentage is another common statistic in baseball and is also quite easy to understand and easy to compute. The primary purpose of this statistic is to gauge the percentage of a pitcher's games that are won.

In some instances, certain statistics become very sophisticated and more difficult to compute. For example, “Game Score” is computed as follows:

GAMESCORE=50+O+2I+S−2H−4R−2U−W, where O=the number of outs recorded; I=the number of innings completed beyond the fourth inning; S=the number of strikeouts; H=the number of hits; R=the number of earned runs allowed; U=the number of unearned runs allowed; and W=the number of walks. This advanced pitching statistic is used to measure how dominant a pitcher's performance is in each game he pitches. This statistic rewards dominance (strikes and lack of hits) while penalizing for walks.

As it clear from the above, the number of statistics that are followed by baseball enthusiasts is rather large. Some of these statistics are, of course, more important than others to either the fans or the ball clubs.

While some of the aforementioned pitching statistics reflect a pitcher's general performance, only some of the statistics reflect the additional pressures and expectations of pitchers during critical phases of the game, when the pitchers are under particular stress. As noted, the “Game Score” is a function of full innings completed beyond the fourth inning and, therefore, reflects the performance of the pitcher toward the second half of the game. Most of the pitching statistics do not, however, reflect other parameters that are inherently stressful to all pitchers and that all good relief pitchers must overcome, including the number of outs, the number of inherited runners and the specific bases where each inherited runner is located when the relief pitcher enters the game. The ability of a pitcher to overcome these stressful conditions, which result from the prior pitcher's actions, and prevent inherited base runners from scoring, has never been quantified. This problem has been discussed in “Top Relievers: Earning Saves by Putting Out Others' Fires” in The New York Times (Jun. 27, 2004) Section 8, page 10. Although this problem has been well defined, to date there has been no practical solution to it.

In an effort to overcome the disadvantages inherent in the statistics used to evaluate the performance of relief pitchers, a method of evaluating the pitching performance of a relief pitcher in the late innings of a baseball game has been disclosed in U.S. Pat. No. 7,092,847 issued on Aug. 15, 2006 to one of the co-inventors of the subject application. The method involved the evaluation of the performance of a relief pitcher in the late innings of a baseball game based on factors existing when a pitcher inherited at least one player on base. The method involved establishing the number of runs scored by such inherited runners and establishing the number of batters faced in such innings. Also, the number of outs and the inning in which the pitcher entered the game were established, and on the basis of these parameters a relief quotient was evaluated by essentially dividing the number of runs scored by such inherited runners by the number of batters faced in such innings. The patent also discussed various coefficients that could be applied to scale the relief quotient in any desired fashion so that the resulting numbers reflecting the relief pitcher's performance could be larger numbers, smaller numbers, or could increase or decrease with enhanced performance. However, it has been determined, upon further analysis and evaluation of the relief quotient proposed in the aforementioned patent, with actual or real statistic as factors, that the relief quotient computed by means of the formulas disclosed in the patent could be improved. Thus, it has been determined that certain parameters, such as the “inning factor” is a less significant factor in establishing a more meaningful relief quotient while the “out factor” also introduced some errors in the form that it was used. Furthermore, primary reliance on the number of batters faced during the final innings of the game, in it of itself, did not provide results that consistently reflected the performance of the relief pitchers exposed to the conditions described. Thus, using the number of batters faced as a denominator was not as effective at reflecting the pitcher's ability as anticipated.

The prior approach intended to show a score on per batter faced basis. As a pitcher faces more batters, this number of batters is bound to increase. The earlier quotient uses a denominator similar to the way that many number do, be it ERA (earned runs per inning), points per game (in basketball) or even miles per hour (speed). It successfully shows a score on a per batter basis. However, this presents a problem.

Using batters as a denominator will decrease the final relief quotient as more batters are faced. This means that if a pitcher faces many batters because he gives up many hits, walks, and ultimately inherited runs, then the higher number of batters faced reflects poor ability. The prior formula assumed that if a pitcher faces more batters, that he has more work to do. This is true, however it may be partly because he has not pitched as effectively as he could have. For example, if two pitchers have equal circumstances for two separate games, but one pitcher faced more batters than the other, it is because the pitcher couldn't end the inning as efficiently as the other pitcher. This fact was overlooked and shows a weakness in the original formula.

The solution was to replace batters faced with appearances in instances with inherited runners. This changes the formula to a score on a per appearance basis. This number accurately reflects ability, because unlike batters faced, the number of the pitcher's appearances is independent of performance ability. Whereas more batters faced could mean both greater workload and lesser ability, a greater number of appearances can only mean greater workload.

Also, it has now been found that using an inning factor ultimately resulted in a skewing of the numbers that left many pitchers incomparable. That is, most pitchers tend to enter the game in certain innings, so the later a pitcher tends to enter into the games he plays, the higher his relief quotient was likely to be. This is because the inning factors increased in the later innings of the game. Thus, the use of the inning factors introduced quotients that did not truly reflect the relief pitcher's abilities.

Furthermore, the earlier approach only considered later innings—the 7^{th} inning or later. Many pitchers enter the game in the 6^{th} inning or earlier, and while this data may not be useful for evaluating the performance of a relief pitcher in the late innings of a baseball game, it is necessary for evaluating the performance of a relief pitcher in instances with inherited runners irrespective of the inning in which the pitcher first appeared.

Finally, the “out” factors had also introduced flawed data. They were dependent on the inning in addition to the number of outs. Now, the “out” factors are based solely on how many “outs” the pitcher must get to finish the inning.

### SUMMARY OF THE INVENTION

Accordingly, it is an object of the invention to provide an improved method of evaluating the performance of a relief pitcher in instances with inherited base runners, that provides an accurate measure of a pitcher's performance and value of the pitcher tinder stressful and/or critical conditions and allows such relief pitchers to be more accurately compared on an objective and/or quantitative basis with other relief pitchers.

It is another object of the invention to provide an improved method, as in the previous object, that factors in parameters such as the number of inherited runners, the bases which they occupy, and the number of outs when the relief pitcher is called in.

It is still another object of the invention to provide a method as in the previous objects which computes a “Relief Quotient” (“RQ”) that is proportional to the total number of runs scored by inherited runners and inversely proportional to the total number of appearances by the pitcher in instances with inherited runners.

It is yet another object of the invention to provide an improved method of the type under discussion which is simple to compute and yet provides a sophisticated and refined method of evaluating and comparing the performances of relief pitchers by considering the number of runs scored by inherited runners and the number of appearances in instances with inherited runners, but which can be refined by also factoring in the positions of those inherited runners as well as the number of outs when the relief pitcher enters the game.

In order to achieve the above objects, as well as others that will become more apparent hereinafter, an improved method of evaluating the performance of a relief pitcher in instances with inherited base runners, in which the pitcher inherits at least one player on base comprises the steps of establishing the number of runs Ri scored by such inherited runners and establishing the number of appearances A by the pitcher in instances with inherited runners.

For the purpose of this application, an “appearance” “A” is defined as any occurrence when a pitcher enters a game and does any pitching whatsoever; whether to one batter, for one inning, or for a number of innings. Therefore, in a set of games, the number of “appearances” is equal to the number of games played by that pitcher. However, the phrase “appearances”, as more specifically used for purposes of this invention, includes instances when appearances are made with inherited runners. Appearances, then, are the number of times, in a set of games, that a pitcher enters a game with inherited base runners. A pitcher is only capable of inheriting base runners in the inning in which he enters of a game that he appears in, so a pitcher cannot have more than one “appearance” per game played.

The Relief Quotient (RQ), in accordance with the present invention, is evaluated by calculating it as follows:

RQ=k[(Ri+E)/A]ⁿ where k=a first predetermined constant selected to scale the RQ to a desired range of magnitudes; Ri=the number of runs scored by inherited runners; A=the number of appearances by the pitcher in instances with inherited runners; E is a second constant, and may be equal to the pitcher's ERA; and n is equal to a predetermined positive or negative number normally equal to +1 or −1.

### BRIEF DESCRIPTION OF THE DRAWINGS

With the above and additional objects and advantages in view, as will hereinafter appear, this invention comprises the devices, combinations and arrangements of parts hereinafter described by way of example and illustrated in the accompanying drawings of preferred embodiments in which:

FIGS. 1A, 1B and 1C are three sections of the same spreadsheet that illustrate one computation of an RQ on the basis of certain game conditions when the relief pitcher is called in;

FIGS. 2A, 2B and 2C are similar to FIGS. 1A, 1B and 1C, but illustrate a second spreadsheet showing different game conditions and the resulting computation of a different RQ for the pitcher.

FIG. 3A is a view of an exemplary computer system suitable for use in carrying out the invention;

FIG. 3B is a block diagram of an exemplary hardware configuration of the computer of FIG. 3A;

FIG. 4 is a block diagram illustrating the method of computing the runs quotient RQ in accordance with the invention, which is preferably performed by a computer of the type shown in FIGS. 3A and 3B; and

FIG. 5 is a block diagram illustrating the manner in which RQ factors for two or more relief pitchers can be compared, displayed, printed and/or transmitted to a remote terminal or location.

### DESCRIPTION OF THE PREFERRED EMBODIMENTS

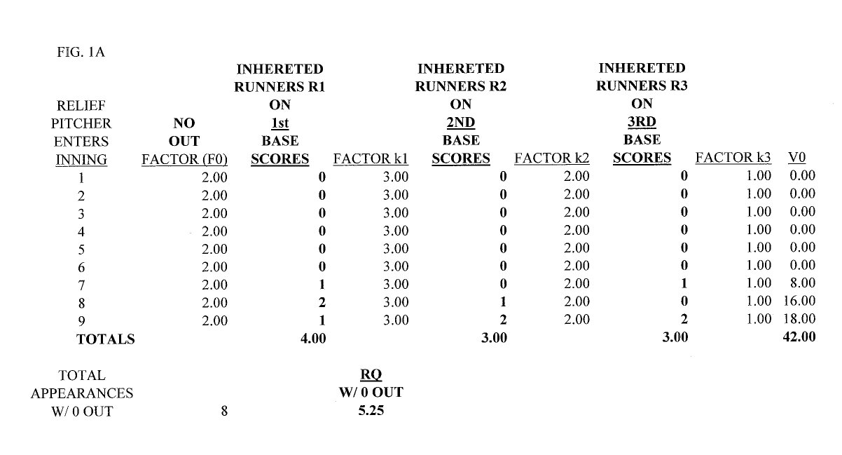

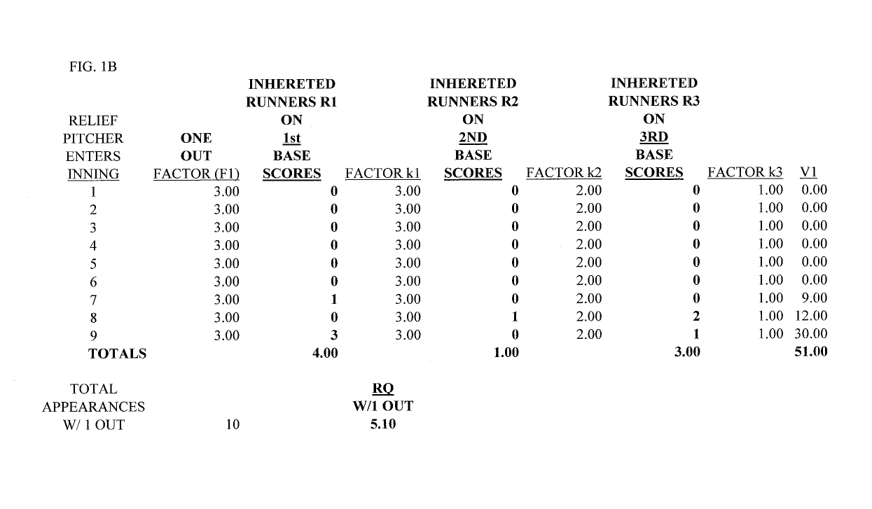

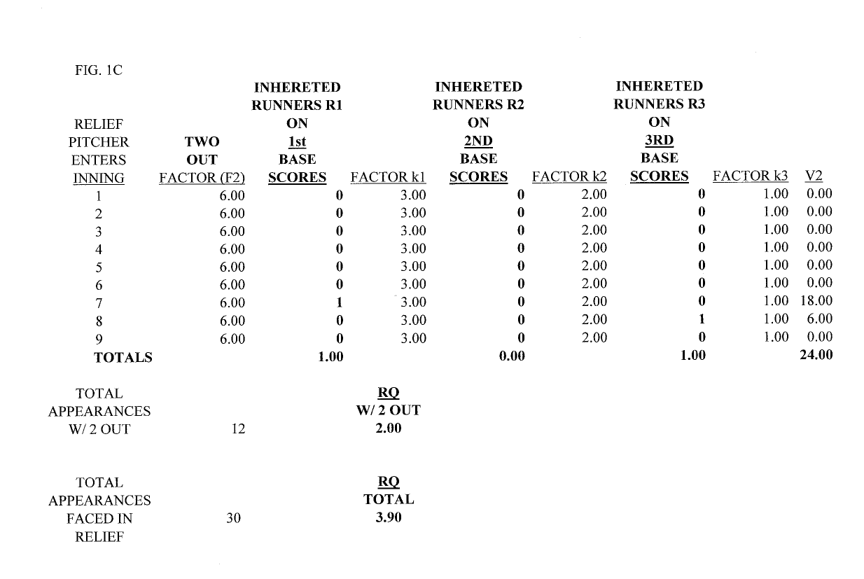

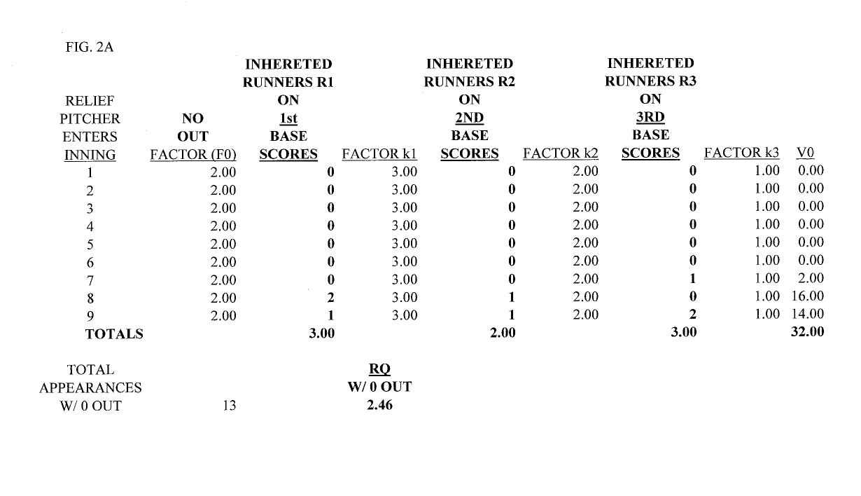

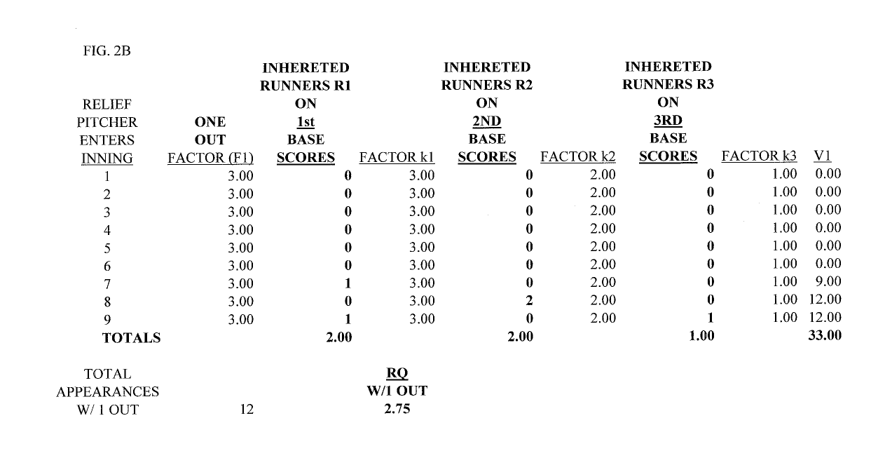

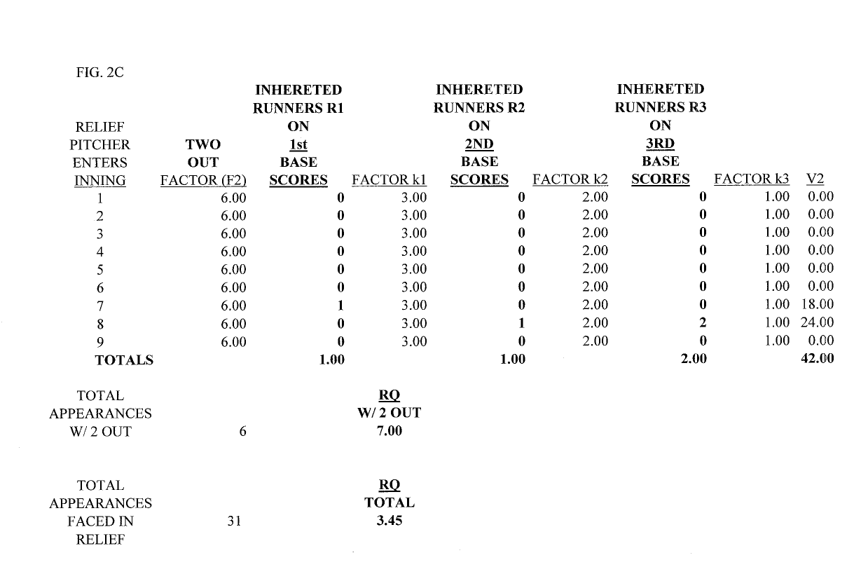

The attached FIGS. 1A, 1B and 1C and 2A, 2B and 2C are two spreadsheets illustrating examples of computations of Relief Quotients (RQs) in accordance with the present invention for two different relief pitchers. This RQ functions to clearly define the value and performance of a relief pitcher in instances with inherited runners. As things are now, a relief pitcher who comes into a game with his team ahead can, in circumstances previously described, receive a “save.” But if several relief pitchers each have achieved the same number of saves, even if they have similar ERA's, will they all have the same value as relief pitchers?

The current use of baseball statistics does not provide an accurate tool by which to measure the value of a relief pitcher in instances with inherited runners. Fortunately, using the RQ statistic, we can now more clearly define relief pitcher superiority and compare relief pitchers more objectively and quantitatively than we could before.

For purposes of this invention, the RQ may either be computed on the basis of the number of outs that exist when the relief pitcher inherits players on base, or may be computed as a composite average for a given relief pitcher that reflects all instances in which players on base(s) are inherited with 0, 1 or 2 outs. Typically, the RQ is proportional to the number of runs Ri scored by players on base inherited by a relief pitcher, and inversely proportional to the total number of appearances in instances with inherited runners. Therefore, in its most fundamental or basic aspect, the improved RQ can be represented as follows:

RQ=k[(Ri+E)/A]ⁿ, where k is a predetermined constant selected to scale the RQ to a selected range of magnitudes, and may be equal to “1”. The exponent “n” may be +1 or −1, as to be more fully discussed below. In the initial embodiment discussed, the exponent is +1. However, as suggested, the RQ can be significantly refined to more fully reflect the value or performance of a relief pitcher in instances with inherited base runners. For purposes of discussing some such refinements, the following definitions will be used:

(1) The Out Factors (F0, F1, F2)—the more outs there are when a relief pitcher enters the game, the more the reliever is penalized for a miscue. For example, if a pitcher enters the game in the eighth inning with no outs and a runner on first base that he allows to score, he is penalized by a factor of 2.0. If he had entered with one out, that factor would have been 3.0, and if he entered with two outs the factor would change to 6.0. These factors are used because he should have less difficulty retiring fewer batters. The penalty reflects the fact that getting 2 outs is twice as difficult as getting one out, and getting 3 outs is three times as difficult as getting one out.

(2) The Base Factors (k1, k2, k3)—Allowing an inherited runner to score from first base takes a greater miscue than allowing an inherited runner to score from second base, which takes a greater miscue than allowing an inherited runner to score from third base. Thus, the pitcher is penalized to a greater extent if the player on first scores under the same conditions as in a situation in which the player on third scores. Reflecting this fact are base factors of 3, 2, and 1 for letting an inherited base runner score from 1^{st}, 2^{nd}, and 3^{rd} base, respectively.

Turning now to specific examples of computations of RQs in accordance with a more refined formula in accordance with the invention, and first referring to FIGS. 1A, 1B and 1C, it should be noted that the tables or spreadsheets show cumulative data for a pitcher over season and not just one game. The RQ may be calculated over a single game, a season or over a lifetime of games for a relief pitcher.

In the initial column, the inning is indicated in which the relief pitcher enters. Recording this information is valuable for the purpose of comparing and contrasting data from the various innings of play.

The second column in FIG. 1A lists a factor of 2.0, reflecting that there are no outs when a relief pitcher might be called in. The “Zero Out Factor” is represented by “F0”; This factor increases as the number of outs increases. Thus, if a pitcher enters the game with no outs, he is not penalized as heavily as if he enters the game with one out or two outs, and allows inherited runners to score. Similar factors F1 and F2 are used where there are 1 or 2 outs at the time the relief pitcher inherits a runner on base.

The third, fifth and seventh columns display the number of inherited runners that have scored from the respective bases when the relief pitcher entered games with inherited runners.

The fourth, sixth and eighth columns list factors k₁, k₂ and k₃. These factors represent parameters that are associated with inherited runners on first base, second base and third base, respectively. It will be noted that the factors k₁, k₂ and k₃ decrease as the position of the inherited runner moves up from first to second to third base. Therefore, if an inherited runner on first base scores, the pitcher will be penalized more severely than if he enters the game with an inherited runner on third base, and that runner scores. With the aforementioned data entered into the respective columns, a first component, “V₀,” is computed as follows: V₀=F0×[(k1×R1)+(k2×R2)+(k3×R3)].

In the ninth column, the value V₀ is computed for each inning during which inherited runners are on base when a relief pitcher enters the game. In the example given in FIG. 1A, in the 7th inning with no outs, this relief pitcher has allowed one inherited runner from 1^{st} base and one inherited runner from 3^{rd} base to score. This yields a quantity V₀=8.00. In the example shown in FIG. 1A, for the 8^{th} inning with no outs, V₀=16, on the basis of two inherited runners from first base and one inherited runner from second base that scored. And in the 9^{th} inning with no outs, V₀=18, on the basis of one inherited runner from first base, two inherited runners from second base and two inherited runners from third base. The V₀ values from the 7^{th}, 8^{th} and 9^{th} innings are added together for a total value of V₀=42.

The tenth column displays the number appearances A made by the pitcher in instances with inherited runners in each inning. In the example of FIG. 1A, this pitcher made such appearances 1 time in the 6^{th} innings, 2 times in the 7^{th} innings, 2 times in the 8^{th} inning, and 3 times in the 9^{th} inning. Adding these values together gives 8 total appearances in instances with inherited base runners.

Similar computations are performed for FIGS. 1B and 1C, in which the factors k₁ k₂ and k₃ are the same as they were in FIG. 1A. The only difference from the first set of columns is that in the second column in this set (FIG. 1B), there is “one out” when the pitcher enters the game. For this reason, we use the one out factor F1, which is greater than F0 of column 2 in FIG. 1A. It will be noted that F1 is greater than F0, because the factor increases when there is one out, as opposed to no outs. Therefore, the pitcher is being more severely penalized if he enters the game with one out and an inherited runner scores than he would be if he had entered the game with no outs and that same runner scored. Using the data from FIG. 1B, a second component “V₁” is computed for each inning as follows: V₁=F1×[(k1×R1)+(k2×R2)+(k3×R3)]. In this case, the total of the V₁ values is 51, and the number of appearances in instances with inherited runners is 10.

Finally, referring to FIG. 1C, similar computations are performed for the last seven columns in which the constants are the same with the exception that we use the 2 out factor F2, which is greater than the factors F0 and F1. For the same reasons mentioned previously, this is to penalize the pitcher more severely in the event that an inherited runner scores when there are two outs when the relief pitcher comes into the game. With the data from FIG. 1C, a third component “V₂” is computed for each inning as follows: V₂=F2×[(k1×R1)+(k2×R2)+(k3×R3)]. In the example shown in FIG. 1C, the total of V₂ is equal to 24, and the number of appearances in instances with inherited runners is 12.

It will be noted that each of the quantities V₀, V₁ and V₂ reflects the number of runs scored, with each run R modified or weighted by the factor multipliers.

The RQ can now been computed as follows, using k=1 and A=30: RQ=1(V₀+V₁+V₂)/A. In the example illustrated, where the pitcher appeared in 30 instances with inherited runners, RQ=1(42+51+24)/30, RQ=3.90.

The constant “1” is not critical for purposes of the present invention and is merely a scaling factor that can be selected to scale the general resulting computer quantity to a number that is manageable, easy to remember or otherwise convenient. The RQ may also be scaled to a number that is generally consistent with other baseball averages, as both fans and clubs may be more familiar and more comfortable with them.

As indicated in FIG. 1A, with a total of 8 appearances by this relief pitcher in instances with inherited runners, without any outs, the RQ may be computed as RQ=42.00/8=5.25.

Similarly, considering the relief pitcher's performance when he is brought in when there is one out, FIG. 1B shows one inherited runner scoring from 1^{st} base in the 7^{th} innings. This translates into V₁=9.00. In the 8^{th} innings, this relief pitcher has had one inherited runners from 1^{st} base, and two inherited runners from 2^{nd} base that scored, for a V₁=12.00. Likewise, in the 9^{th} innings, this pitcher has had three runners from 1^{st}, and one runner from 3^{rd} that scored, for a V₁=30.00. This pitcher appeared in instances with 1 out and inherited base runners 2 times in the 7^{th} inning, 4 times in the 8^{th} inning, and 4 times in the 9^{th} inning. The three values of V₁, summed equal 51.00, and the summed values of A equal 10 so when we compute RQ as RQ=51/10=5.10.

Finally, in FIG. 1C, this same relief pitcher is shown to have given up one inherited runner from 1^{st} base in the 7^{th} innings, which again translates into a V₂=18.00. In the 8^{th} innings, he had one inherited runners from 3^{rd} base score, for a V₂=6.00. The total of the V₂ quantities is, therefore, 24.00. The number of appearances in instances with inherited runners and two outs is the sum of 1 time in the 5^{th} inning, one time in the 6^{th} inning, 4 times in the 7^{th} inning, 3 times in the ₈th inning, and 3 times in the 9^{th} inning, for a total of 12. This gives an RQ of 24/12=2.00.

Considering all of the games in which the pitcher was called in and had to deal with inherited runners, the overall performance of this relief pitcher can be computed as the sum of all the “V”-quantities, namely, V₀, V₁ and V₂, divided by the total appearances in instances with inherited runners, which, in the example, equals 8+10+12=30. This provides a “total” RQ for this relief pitcher of 3.90.

In FIGS. 2A, 2B and 2C, similar computations are made in which different numbers of inherited runners are found on different bases with different numbers of outs. Here, using similar computations, the overall or “total” RQ for the second pitcher is 3.45 after having made 31 appearances in instances with inherited runners. Similar computations can, of course, be made for all pitchers who are called in to relieve an existing pitcher and who are faced with inherited runners on base.

All these RQ numbers can then saved in a database and compared to each other. It is possible, then, to also compare relief pitchers insofar as their performance is concerned when called into a game with a certain number of outs but with inherited runners on base. In the two examples shown, in FIGS. 1C and 2C, which display RQ with 2 outs, the pitcher represented by the figures in 1A is the superior pitcher, as his RQ is 2.00, whereas the second pitcher has an RQ of 7.00. If both of these relief pitchers are on the same team, the manager of a baseball club may decide in a critical game, to use the first relief pitcher under circumstances in which there are two outs. The opposite would be true if such relief pitchers were compared at a time when there is one out when a relief pitcher was needed, the first pitcher having an RQ, under those circumstances, of 5.10, while the second pitcher has an RQ of 2.75. Finally, if required to select a relief pitcher in any game in which there are no outs and inherited runners exist, the second relief pitcher has still demonstrated that he performs better under those conditions, with an RQ=2.46, whereas the first pitcher has an RQ of 5.25. Such superior performance is also reflected in the “total” or overall better RQ for the second pitcher of 3.45 as compared to the “total” RQ of the first pitcher, which is equal to 3.90.

It is also possible, then, to compare relief pitchers based on their performances with inherited runners, as it relates to what inning they entered the game. For example if we want to compare these two pitchers based on how they perform in the 9^{th} inning with inherited runners on base, let us first take a look at the pitcher from FIGS. 1A, 1B, and 1C. In 9^{th} innings with no outs, his V₀ is 18.00 and he made 3 appearances when runners were on base. In 9^{th} innings with one out, his V₁ is 30.00 and he made 4 appearances when runners were on base. In 9^{th} innings with two outs, his V₂ is 0.00 and he made 3 appearances when runners were on base. So for 9^{th} innings, he made A=3+4+3=10 appearances with inherited runners, and his V₀+V₁+V₂=18+30+0=48. So the first pitcher's RQ in 9^{th} innings is 48/10; RQ=4.80. Now, at looking at the second pitcher in 9^{th} innings with no outs, his V₀ is 14.00 and he made 5 appearances when runners were on base. In 9^{th} innings with one out, his V₁ is 12.00 and he made 4 appearances when runners were on base. In 9ₜₕ innings with two outs, his V₂ is 0.00 and he made 1 appearance when runners were on base. So for 9^{th} innings, he made A=5+4+1=10 appearances with inherited runners, and his V₀+V₁+V₂=14+12+0=26. So the second pitch's RQ in 9^{th} innings is 26/10; RQ=2.60. Not only is the second pitcher superior to the first pitcher in 9^{th} inning appearances with inherited runners, as evident by his lower RQ, but when we compare the second pitcher's 9^{th} inning RQ of 2.60 to his total RQ of 3.45, it becomes clear that he is relatively successful during 9^{th} innings appearances with inherited runners. This is in contrast to the first pitcher whose 9^{th} inning RQ=4.80, well above his total RQ of 3.90. Numbers such as these can be crucial in deciding when to use one relief pitcher instead of another. They can also tell you if you should wait, for example, until a specific inning before putting a certain reliever in the game.

The distinctions between the RQ and ERA become immediately evident. Thus, for example, in a nine-inning game, with three outs per inning, there are a total of 27 outs. In the ideal game, therefore, there are 27 batters out in one game. The ERA, as noted above, is equal to the number of runs divided by the number of batters, itself divided by 27 (the number of outs). Therefore, in the ideal game, the number of runs is equal to zero, and the ERA is equal to zero. However, if the number of runs is equal to 1, the ERA is equal to 1. If the pitcher faces 54 batters, the ERA is equal to 0.5. Stated otherwise, the ERA is a reflection of the number of runners who have scored for every 27 outs. However, this is without regard to the number of inherited runners, the bases on which the inherited runners were on, etc. However, the RQ provides more accurate or meaningful information about the performance of the relief pitcher in instances with inherited runners. Thus, if a greater number of inherited runners score, the RQ is higher. The RQ also increases if such runs are scored by a pitcher entering with a greater number of outs, or if those runners scored from lower bases.

It will be evident, therefore, that the RQ provides a more accurate and more complete picture of the capabilities or performance of a relief pitcher in the circumstances described. By using the formula for the RQ, in its broader or more refined form, a numerical value can be placed on what the relief pitcher has achieved, or failed to achieve. In other words, a relief pitcher's ERA doesn't tell the whole story. The RQ in accordance with the present invention makes the necessary adjustment to reflect this and serves as a valuable tool and criterion for analysis when comparing relief pitchers.

Although this invention has been described in detail with particular reference to preferred embodiments thereof, it will be understood that variations and modifications may be effected within the spirit and scope of the invention as described herein and as defined in the appended claims. Thus, for example, the formula can be modified to add, delete or give different weights to the out factors F0, F1, and F2, as well as the base factors, k₁, k₂, and k₃, that serve as multipliers for the runs R1, R2 and R3. This endows the user of the formula the ability to penalize a pitcher more or less as conditions vary. The factors can be incrementally increased or decreased, or can be inverted and adjusted as a divisor instead of a multiplier in the equation, so that for example, V₀=F0(R1/k1+R2/k₂+R3/k₃) instead of V₀=F0(R1*k1+R2*k₂+R3*k₃). Additional factors not currently reflected in the equations for the RQ might also be added—such as, for example, whether the game is a night game, poor weather conditions (e.g., rain)—all of which may make it easier or more difficult for a pitcher to perform well.

As suggested previously, the exponent “n” can be any value that provides desired or reasonable values for RQ. Thus, “n” can be whole integers, fractions or any other numeric quantity. In accordance with the currently preferred realizations, normally n=1 or n=1. Thus, for example, the RQ for the pitcher in FIGS. 1A, 1B, and 1C has been computed with n=1, so that the quantity (V₀+V₁+V₂) remains in the numerator while the quantity A remains in the denominator, yielding RQ=3.90 when k=1.

It is clear that when n=1, the RQ is proportional to the number of runs Ri scored and inversely proportional to the number of appearances A in instances with inherited runners, so that as the ability of the relief increases, the RQ decreases. By scaling the constant k, RQ can be greater or less than one. If an inverse relationship is desired, “n” can be made equal to −1, which thereby places “A” in the numerator and “R” in the denominator. Again, k can be selected to provide any scale factor.

However, when n=1, as the ability of the relief pitcher improves, the RQ decreases. Again, the absolute values can be adjusted by selecting a suitable value of k. In the examples given in FIGS. 1A, 1B, and 1C, with k remaining at 1, selecting n=−1 would make RQ=1*(30/117)=0.26, instead of 3.90. It will be clear that reversing the sign of the exponent “n” simply reverses the trend for the pitchers—either the RQ increases or decreases as the player exhibits more and more (or less and less) skill.

The above method may be presented in terms of program procedures executed on a computer or network of computers. These procedural descriptions and representations are the means used by those skilled in the art to most effectively convey the substance of their work to others skilled in the art.

Here, generally, a “procedure” is conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or similar devices.

The present invention also relates to apparatus for performing these operations. This apparatus may be specially constricted for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

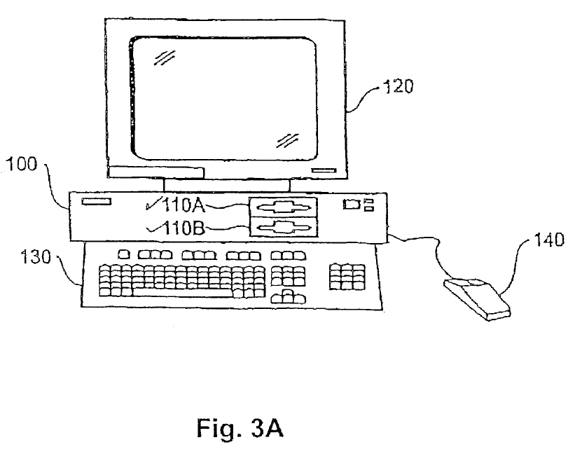

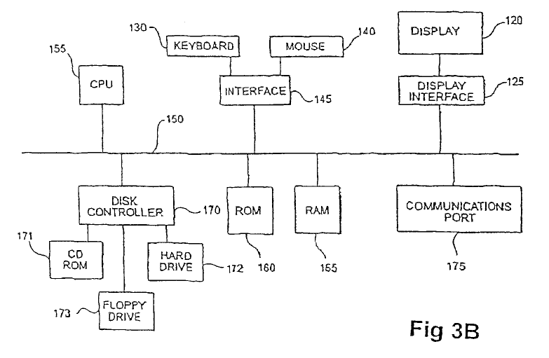

FIG. 3A illustrates a computer of a type suitable for carrying out the invention. Viewed externally in FIG. 3A, a computer system has a central processing unit 100 having disk drives 110A and 110B. Disk drive indications 110A and 110B are merely symbolic of a number of disk drives which might be accommodated by the computer system. Typically, these would include a floppy disk drive such as 110A, a hard disk drive (not shown externally) and a CD ROM or DVD drive indicated by slot 110B. The number and type of drives vary, typically, with different computer configurations. The computer has a display 120 upon which information is displayed. A keyboard 130 and mouse 140 are typically also available as input devices. The computer illustrated in FIG. 1A may be a SPARC workstation from Sun Microsystems, Inc.

FIG. 3B illustrates a block diagram of the internal hardware of the computer of FIG. 3A. A bus 150 serves as the main information highway interconnecting the other components of the computer. CPU 155 is the central processing unit of the system, performing calculations and logic operations required to execute programs. Read only memory (160) and random access memory (165) constitute the main memory of the computer. Disk controller 170 interfaces one or more disk drives to the system bus 150. These disk drives may be floppy disk drives, such as 173, internal or external hard drives, such as 172, or CD ROM or DVD (Digital Video Disks) drives such as 171. A display interface 125 interfaces a display 120 and permits information from the bus to be viewed on display. Communications with external devices can occur over communications port 175. A data base of any conventional or suitable format may be provided and stored on any of the storage media 171, 172, 173, etc.

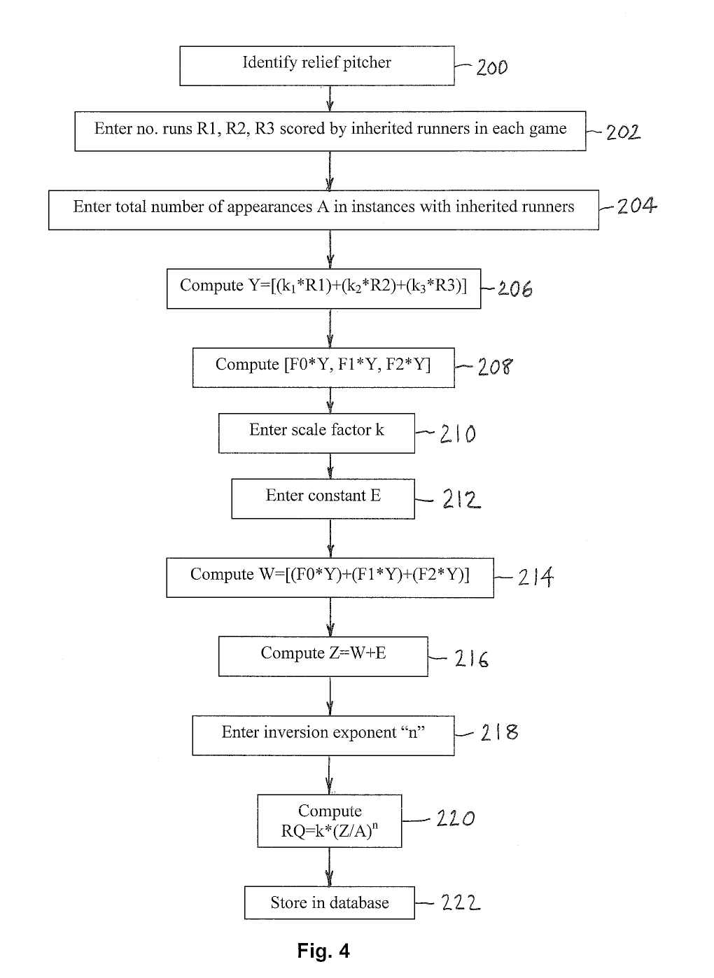

Referring to FIG. 4, a block diagram is shown that illustrates the method of computing the runs quotients RQ in accordance with the invention, which is preferably performed by a computer of the type shown in FIGS. 3A and 3B. When performed by a computer, FIG. 4 illustrates the data that is entered into the computer as well as the computations performed by the computer on the basis of certain desired characteristics or properties for the RQ. Initially, a database needs to be created for each relief pitcher or group or universe of pitchers. To do this, the identity of each individual pitcher is inputted into the computer at 200. For that given pitcher, the number of runs “R1,” “R2” and “R3” is then inputted, representing the runs scored by the players that have been inherited by the relief pitcher, at 202. At 204, the total number of appearances “A” of the relief pitcher in instances with inherited runners are entered or inputted. Once the aforementioned information has been inputted, the computer is instructed to use the base factors k₁, k₂ and k₃ to compute the quantity Y=[(k₁*R1)+(k₂*R2)+(k₃*R3)], at 206. Once the quantity Y has been computed, that quantity is multiplied by the out factors F0, F1 and F2 to obtain the products (F0*Y), (F1*Y) and (F2*Y), at 208.

As aforementioned, the quantities can be scaled up or down depending on the general size or magnitude of the desired RQ quantity. The scale factor “k” is entered at 210, and a parameter E is entered at 212. As will become evident, the parameter E at 212 can be 1 or 0 or any desired quantity.

At 214 an intermediate quantity W is then computed by multiplying the intermediate quantity Y in accordance with the following relationship:

W=[(F0*Y)+(F1*Y)+(F2*Y)].

At 216 another intermediate parameter, Z, is computed to be equal to: Z=W+E. An inversion exponent “n” is then inputted at 218, depending whether the preference is to have the RQ quantity increase with better relief pitcher performance, or whether the quantity needs to be decreased. It should be clear, therefore, that for positive values of “n”, lower values of the RQ parameter represent pitchers who have performed better, while the quantities increases as the performance decreases. The reverse is true for negative values of the inversion exponent “n”, since a negative exponent will invert the value of the RQ quotient, so that the larger the quantity, the better the performance.

The RQ is computed at 220 in accordance with the following relationship:

RQ=k*(Z/A)ⁿ

This quantity can then be stored in a suitable database, at 222. The computation of the RQ can be simplified if “E” is made equal to 0. However, the quantity “E” has been include in the generalized formula to accommodate the situation in which the inversion exponent “n” is negative, and the quantity “W” is equal to 0, as this would lead to very large, and even infinite, quantities for RQ. In this way, even if the quantity “W” is equal to 0, the ratio A/W can still be made to be a finite quantity. However, when the inversion exponent “n” is positive, the quantity W remains in the numerator, and the quantity E may be superfluous, and may be omitted. Under the conditions of the positive values of “n”, the basic equation for the RQ can be reduced to: RQ=(W/A)ⁿ

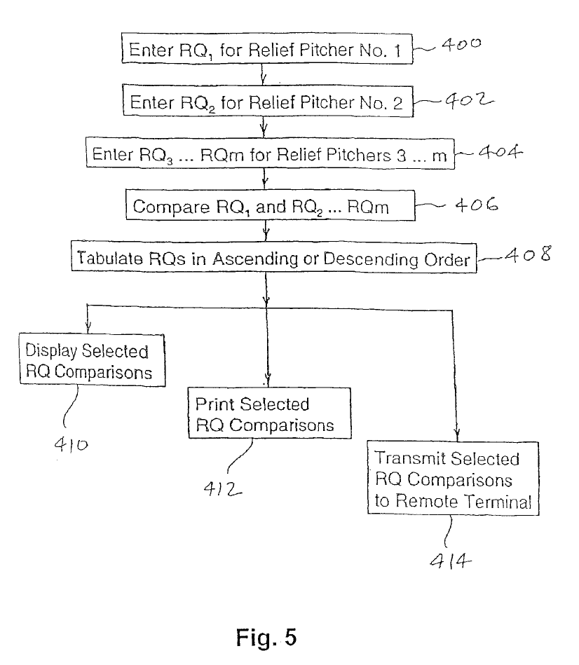

In FIG. 5 a practical application of the invention is illustrated. After the RQ is calculated for all relief pitchers of interest, this information is stored in a database, at 400, 402, 404. Once the “RQ”s—RQ1, RQ2 . . . RQm—have been stored, this information can readily be used to compare the RQ for any given pitcher to those of the others, at 406. This information can then be tabulated or displayed in any desired format, such as ascending or descending order, at 408. Once structured or tabulated, the information can be displayed, at 410, printed, at 412, or transmitted to a remote terminal, at 414.

It should be evident that this information presented as suggested would be extremely useful to owners of sports teams, managers, fans, sports publications and the like, both to appreciate the relative performances of relief pitchers and for assessing future decisions on the basis of past performance.

What is claimed is:

1. A method of evaluating the performance of a relief pitcher in instances with inherited base runners in which the pitcher inherits at least one player on base, the method comprising the steps of establishing the number of runs Ri scored by such inherited runners; establishing the number of appearances A in instances with inherited runners; evaluating the Relief Quotient “RQ”, where: RQ=k[(Ri+E)/A]ⁿ, where k is first a predetermined constant selected to scale the RQ to a desired range of magnitudes, n is a second predetermined constant that may be positive or negative and E is a parameter that may be an integer or equal to 0; and storing RQ in a tangible medium for subsequent use.

2. A method as defined in claim 1, wherein the runs Ri are modified or weighed by at least one factor reflecting a condition in the baseball game at the time that the relief pitcher is brought into the game.

3. A method as defined in claim 2, wherein the runs Ri are modified by a plurality of weighted factors.

4. A method as defined in claim 2, wherein said factor is a function of the number of outs.

5. A method as defined in claim 4, wherein said factor increases with the number of outs.

6. A method as defined in claim 2, wherein said factor is a function of the base on which the inherited runner is on.

7. A method as defined in claim 6, wherein said factor decreases as the base number increases.

8. A method as defined in claim 1, wherein a constant “k” is selected to provide an RQ in the range of 0-100.

9. A method as defined in claim 1, wherein said RQ is computed on the basis of a pitcher's performance within at least a part of one season.

10. A method as defined in claim 1, wherein said RQ is compiled on a pitcher's performance over a lifetime of pitching.

11. A method as defined in claim 1, wherein the RQ is compiled as follows:
RQ=kx{{F0[(k₁×R1)+(k₂×R2)+(k₃×R3)]+F1[(k1×R1)+(k2×R2)+(k3×R3)]+F2[(k1×R1)+( k2×R2)+(k3×R3)]+E}÷A}¹, wherein k is a scaling factor; k₁, k₂ and k₃ are all base scaling factors; F0, F1 and F2 are the “No. of Out” factors; R1, R2 and R3 are the runs scored from 1^{st}, 2^{nd} and 3^{rd} base, respectively; n is a predetermined constant that may be positive or negative; E is an arbitrary factor for use particularly when “n” is a negative number; and A is the total number of appearances in instances with inherited runners by the pitcher.

12. A method as defined in claim 1, wherein n is positive.

13. A method as defined in claim 1, wherein n is negative.

14. An apparatus for evaluating the performance of a relief pitcher in instances with inherited base runners, in which the pitcher inherits at least one player on base, comprising: means for establishing the number of runs Ri scored by such inherited runner; means for establishing the number of appearances A in instances with inherited runners; means for evaluating the Relief Quotient “RQ”, where: RQ=k(Ri+E/A)ⁿ, and k is first a predetermined constant selected to scale the RQ to a desired range of magnitudes and n is a second predetermined constant; and means for storing RQ in a tangible medium for subsequent use.

15. An apparatus as defined in claim 14, wherein said evaluation means comprises a computer programmed to perform the required computations when the number of runs (Ri) number of appearances (A) in instances with inherited runners are entered.

16. An apparatus as defined in claim 14, wherein n is positive.

17. An apparatus as defined in claim 14, wherein n is negative.

18. A device for evaluating or comparing the performance or efficiency of a relief pitcher in instances with inherited base runners, in which the pitcher inherits at least one player on base, the device comprising means for providing a quantity defined as follows: RQ=k*(Ri+E)/A)ⁿ, where Ri is equal to the number of runs scored by the inherited runners, A is the number of appearances by the pitcher in instances with inherited runners, and k is a first predetermined constant selected to scale the RQ to a desired range of magnitudes and n is a second predetermined constant, said quantity being storable in a tangible medium for subsequent use.

19. A device as defined in claim 18, wherein the RQ is compiled as follows: RQ=k{F0[(k₁×R1)+(k₂×R2)+(k₃×R3)]+F1[(k1×R1)+(k2×R2)+(k3×R3)]+F2[(k1×R1)+(k2×R2)+(k3×R3)]]+E}÷A}ⁿ, wherein k is a scaling factor; k₁, k₂ and k₃ are all base scaling factors; F0, F1 and F2 are the “No. of Out” Factors; R1, R2 and R3 are the runs scored from 1^{st}, 2^{nd} and 3^{rd} base, respectively; n is a predetermined constant that may be positive or negative; E is an arbitrary factor for use particularly when “n” is a negative number; and A is the total number of appearances in instances with inherited runners by the pitcher.

20. A device as defined in claim 18, wherein k is selected to provide an RQ in the range of 1-100.

21. A device as defined in claim 18, wherein said RQ is computed on the basis of a pitcher's performance within at least a part of one season.

22. A device as defined in claim 18, wherein said RQ is compiled on a pitcher's performance over a season of pitching.

23. A device as defined in claim 18, wherein n is positive.

24. A device as defined in claim 18, wherein n is negative.

25. A method of evaluating a performance measure of a relief pitcher in a baseball game, wherein same relief pitcher inherits at least one player on base upon entering the game, the method comprising: a first step of establishing the number of runs Ri scored by such inherited runners; a second step of establishing the number of appearances A in instances with inherited runners; a third step of calculating a Relief Quotient “RQ”: RQ=k(Ri+E/A), wherein k is first a predetermined constant selected to scale the RQ relative to a desired range of magnitudes suitable for easy comparison, and n is a second predetermined constant selected from a group including at least one of +1 and −1, and E is a parameter that may be an integer or equal to 0; and storing RQ in a tangible medium for subsequent use.

26. A method of calculating a performance measure of a relief pitcher in a baseball game, wherein said relief pitcher inherits at least one player on base upon entering the game, the method comprising: a first step of establishing the number of rtms Ri scored by such inherited runners; a second step of establishing the number of appearances A in instances with inherited runners; a third step of calculating a Relief Quotient “RQ”: RQ=k(Ri+E/A)ⁿ, wherein k is first a predetermined constant selected to scale the RQ relative to a desired range of magnitudes suitable for easy comparison, and n is a second predetermined constant selected from a group including at least one of +1 and −1, and E is a parameter that may be an integer or equal to 0; and storing RQ in a tangible medium for subsequent use.

27. A method of calculating a performance measure of a designated relief pitcher in a selected baseball game relative to a calculated average of a plurality of relief pitchers in a plurality of baseball games, wherein each said relief pitcher inherits at least one player on base upon entering the game, the method comprising: a first step of monitoring and recording a performance of said plurality of relief pitchers in said plurality of baseball games wherein said step of recordation includes the recordation, for each relief pitcher, of the number of runs Ri scored by such inherited ruiners and the recordation of the number of appearances A in instances with inherited runners; a second step of calculating and recording a Relief Quotient “RQ” as a performance measure for each of said plurality of relief pitchers in an accessible database in accordance with the following equation: RQ=k(Ri+E/A)ⁿ, wherein k is first a predetermined constant selected to scale the RQ relative to a desired range of magnitudes suitable for easy comparison, and n is a second predetermined constant selected from a group including at least one of +1 and −1, and E is a parameter that may be an integer or equal to 0; a third step of calculating and recording an average Relief Quotient and a best possible Relief Quotient of said plurality of relief pitchers in said accessible database; a fourth step of monitoring and recording a performance of said designated relief pitcher in said selected baseball game; a fifth step of calculating and recording a Relief Quotient “RQ” of said designated relief pitcher in said database according to said equation; a sixth step of comparing said Relief Quotient from said designated relief pitcher to at least one of said average Relief Quotient and said best possible Relief Quotient to evaluate said performance of said designated relief pitcher; and storing RQ in a tangible medium for subsequent use in at least one of said third through sixth steps.
